(19) United States
(12) Patent Application Publication
(10) Pub. No.: US 2009/0259999 A1
(43) Pub. Date: Oct. 15, 2009

(54) METHOD AND SYSTEM FOR APPLYING A PATCH DURING APPLICATION EXECUTION

(75) Inventor: Kesavan Srinivasan, Hudson, OH (US)

Correspondence Address: PVF -- ORACLE INTERNATIONAL CORPORATION;c/o PARK, VAUGHAN & FLEMING LLP, 2820 FIFTH STREET, DAVIS, CA, 95618-7759, US

(73) Assignee: ORACLE INTERNATIONAL CORPORATION, Redwood Shores, CA (US)

(21) Appl. No.: 12/101,542

(22) Filed: Apr. 11, 2008

(51) Int. Cl. G06F 9/44

(52) U.S. Cl. 717/170

(57) ABSTRACT

Some embodiments of the present invention provide a system that applies a patch to an application during execution of the application. During operation, the system obtains source code for the patch and constructs a shared library from the source code. Next, the system dynamically loads the shared library into the application. Finally, the system replaces an old version of a function in the application with a new version of the function from the shared library, which changes the execution of the application in accordance with the patch.

### BACKGROUND

1. Field

The present invention relates to techniques for applying a patch to an application during execution of the application.

2. Related Art

Software patches are commonly released to fix bugs, install new features, improve existing features, replace graphics, and/or change other attributes of a software program. These patches may vary in size, form, and/or method of application. For example, a patch may be released as a single source code file, which may be applied by compiling and linking the source code file into the software program. Alternatively, the user of the software program may execute a software update program that automatically installs the patch from multiple binary files.

Regardless of how patches are installed, the software program is typically shut down prior to installing or uninstalling a patch. As a result, the software program is unavailable for use during patch installation and uninstallation operations, which in turn may create problems for users of the software program and/or its services. For example, a website may undergo scheduled maintenance while patches are applied to database software in the backend of the website. The limited availability of the website during scheduled maintenance may result in lost revenue, and may generally degrade user satisfaction.

### SUMMARY

Some embodiments of the present invention provide a system that applies a patch to an application during execution of the application. During operation, the system obtains source code for the patch and constructs a shared library from the source code. Next, the system dynamically loads the shared library into the application. Finally, the system replaces an old version of a function in the application with a new version of the function from the shared library, thereby changing the execution of the application in accordance with the patch.

In some embodiments, replacing the old version of the function involves changing a reference to the old version to refer to the new version.

In some embodiments, the old version of the function is included in an old version of the patch.

In some embodiments, the system also uninstalls the patch during application execution by removing the reference to the new version of the function.

In some embodiments, the application is implemented to be executed by multiple processes.

In some embodiments, the patch is applied to some of the processes.

In some embodiments, the application is a relational database management system (RDBMS).

In some embodiments, the patch provides a bug fix, a security fix, a compatibility fix, a diagnostic, an additional feature of the application, or an update to an existing feature of the application.

### BRIEF DESCRIPTION OF THE FIGURES

FIG. 1 shows a schematic of a system in accordance with an embodiment of the present invention.

FIG. 2 shows a flowchart illustrating the process of patch installation on an application with multiple executing processes in accordance with an embodiment of the present invention.

FIG. 3 shows a flowchart illustrating the process of applying a patch to an application during execution of the application in accordance with an embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

Embodiments of the invention provide a method and system for applying patches to an application, such as a driver, an operating system, an enterprise software solution, and/or a relational database management system (RDBMS). The application may be implemented to be executed using multiple processes, such as in a multi-process architecture. In addition, each of the patches may provide a bug fix, a security fix, a compatibility fix, a diagnostic, an additional feature of the application, and/or an update to an existing feature of the application.

More specifically, embodiments of the invention provide a method and system for applying patches to the application without interrupting the execution of the application. In other words, embodiments of the invention enable patches to be applied to the application without shutting down the application. Each patch may be generated by constructing a shared library from the patch's source code. The shared library may then be dynamically loaded into the application and installed by replacing old versions of functions in the application with new versions of the functions from the shared library. In one or more embodiments of the invention, the old versions of the functions are replaced by changing references to the old versions to refer to the new versions. Moreover, each patch may be uninstalled during application execution by removing the references to the new versions of the functions.

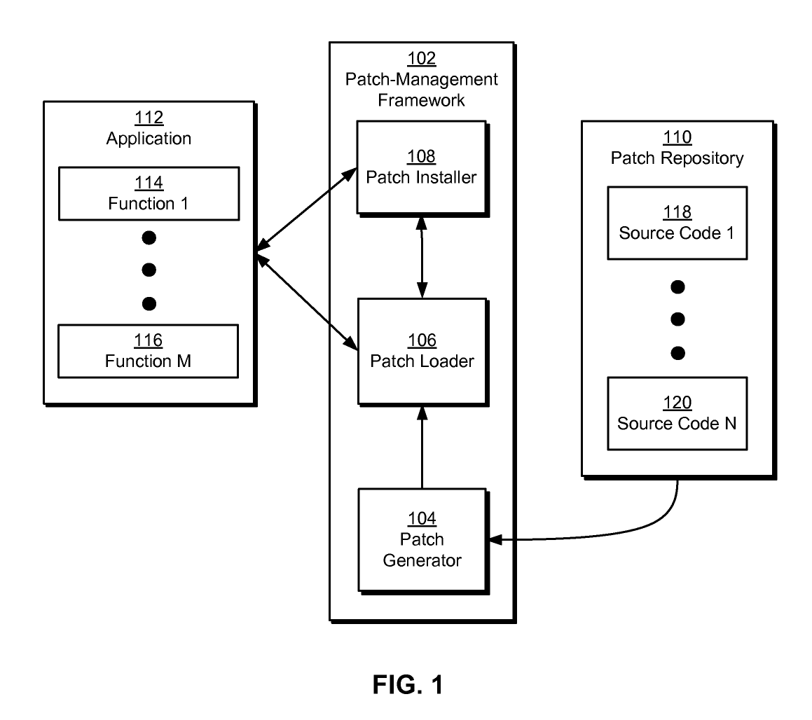

FIG. 1 shows a schematic of a system in accordance with an embodiment of the present invention. As shown in FIG. 1, the system includes a patch-management framework 102, a patch repository 110, and an application 112. Each of these components is described in further detail below.

Application 112 may correspond to software that is used to perform a specific set of tasks for a user of the software. For example, application 112 may be a word processing application, an email client, an operating system, a relational database management system (RDBMS), and/or a web browser. In addition, application 112 may be executed in a variety of environments using one or more processes. For example, application 112 may be executed using a single process on a single desktop computer or workstation, or application 112 may be executed using multiple processes running on different servers within a data center.

As shown in FIG. 1, application 112 includes multiple functions (e.g., function 1 114, function m 116). Each function may correspond to a module or subcomponent within application 112 that is defined using code, such as source code or machine code. The code may be written in one or more programming languages by a developer of application 112. Alternatively, code for some functions in application 112 may be automatically generated. For example, application 112 may include functions written in assembly by a developer, as well as C or C++ functions automatically generated using a model of application 112.

More specifically, functions may refer to individual software modules that perform specific tasks within application 112. For example, an enterprise solution may include functions that implement various features of an RDBMS, such as features for handling queries, creating and deleting database entries, creating and deleting tables, and/or managing user accounts. In addition, the functionality of application 112 may be produced by the interaction of the functions with one another. For example, inserting a database entry into the RDBMS may be implemented by calling functions for receiving a database query for inserting the database entry, retrieving the database corresponding to the query, and writing the entry into the database.

Those skilled in the art will appreciate that the lifecycle of application 112 may involve changes or updates to application 112. The changes or updates may include bug fixes, security fixes, compatibility fixes, diagnostics, additional features, and/or updates to existing features of application 112. In one or more embodiments of the invention, changes to application 112 are carried out using patches. Furthermore, these patches may be obtained and applied to application 112 using patch management framework 102.

In one or more embodiments of the invention, source code (e.g., source code 1 118, source code n 120) for the patches is stored in patch repository 110. Those skilled in the art will appreciate that the source code for each patch may vary in size, form, and/or purpose. For example, patch repository 110 may contain large bodies of high-level code corresponding to service packs of application 112, as well as smaller, lower-level code sets corresponding to bug fixes or diagnostics. As with functions (e.g., function 1 114, function m 116) in application 112, the source code for the patches may be written by a developer of application 112 and/or automatically generated using a model of application 112.

Once source code for patches becomes available in patch repository 110, the source code is accessible by patch-management framework 102. In one or more embodiments of the invention, patch-management framework 102 is responsible for managing the use of patches on application 112. In other words, patch-management framework 102 may be used to obtain source code for patches from patch repository 110, prepare the patches from the source code, apply the patches to application 112, and/or uninstall patches from application 112. In addition, patch-management framework 102 may install and/or uninstall patches during the execution of application 112, as explained below.

In one or more embodiments of the invention, patches are generated from source code in patch repository 110 using a patch generator 104 within patch-management framework 102. More specifically, patch generator 104 may compile the source code into a form that is usable by application 112. For example, patch generator 104 may correspond to a Java (Java™ is a registered trademark of Sun Microsystems, Inc.) compiler that compiles Java source code from patch repository 110 into Java bytecode. Alternatively, patch generator 104 may correspond to a C++ compiler that generates object code from C++ source code in patch repository 110. Patch generator 104 may further include the capability to generate usable patches for application 112 from source code in a variety of programming languages.

In one or more embodiments of the invention, patch generator 104 constructs patches as shared libraries from source code in patch repository 110. Examples of shared libraries include Unix shared libraries, Unix shared objects, and/or Windows dynamically liked libraries (DLLs). In one or more embodiments of the invention, shared libraries generated by patch generator 104 are dynamically loaded into application 112 using a patch loader 106 in patch-management framework 102. Because dynamic loading occurs at runtime, application 112 may continue to execute as shared libraries are added to application 112. In other words, patch-management framework 102 may provide mechanisms for generating and loading patches into the address space of application 112 without shutting down application 112.

Those skilled in the art will appreciate that changes provided by patches loaded into application 112 are executed through function calls into the loaded patches (i.e., shared libraries). Moreover, such changes may be enacted by substituting calls to one or more functions of application 112 for calls to analogous functions provided by the patches. For example, application 112 may be released with a function that contains a bug. The bug may be fixed by dynamically loading a patch containing a bug-free version of the function into application 112 and calling the bug-free version from application 112 in lieu of the original buggy version.

In one or more embodiments of the invention, function calls into the loaded patches from application 112 are enabled by a patch installer 108 in patch-management framework 102. To enable use of the loaded patches, patch installer 108 may replace old versions of functions in application 112 with new versions of the functions from the patches. In particular, patch installer 108 may replace an old version of a function in application 112 by changing a reference to the old version to refer to the new version. Similarly, patches may be uninstalled by removing references to functions provided by the patches. As with the loading of the patches, the swapping of references between older and newer versions of functions may take place during runtime, thus allowing changes provided by the patches to be enacted without interrupting the execution of application 112.

Those skilled in the art will appreciate that references between different function versions may be changed in multiple ways. For example, application 112 may include a symbol table that contains references to all functions used by application 112. Prior to the addition of a particular patch, the symbol table may contain references to functions from the original release of application 112 and/or older patches. After the patch is dynamically loaded into application 112, new versions of functions from the patch are located within the address space of application 112 and the symbol table is updated using the addresses of the new versions. Thus, calls to the functions result in calls to the new versions of the functions rather than to older versions.

On the other hand, references to the new versions of the functions may be placed within old versions of the functions. For example, application 112 may be released with an original set of functions. Each of the original set of functions may contain a body of code that is executed by application 112 prior to the loading of any patches. When a patch is loaded into application 112, the original functions are rewritten to refer to the new versions of the functions. In particular, the body of an original function may be replaced with a pointer, an assembly “jump” command, and/or other directive that reroutes to the new version from the patch.

Thus, a function in application 112 may continually be replaced in a series of patches by updating references to the function as the patches are loaded. For example, an original function within application 112 may be replaced in a first patch by referencing the version of the function from the first patch instead of the original function. If a second patch containing a newer version of the function is subsequently released, the reference to the version from the first patch is replaced with a reference to the newer version from the second patch, resulting in both a rollback of the first patch's version of the function and the utilization of the newer version. As described above, such reference updates may be accomplished either by updating a symbol table for application 112, or by changing the body of the original function to point to the newest version.

Once application 112 utilizes functions from installed patches, the execution of application 112 is changed in accordance with the patches. As mentioned previously, such changes are made dynamically, thus allowing application 112 to continue executing while the patches are applied. Furthermore, if application 112 is executed using multiple processes, patches may be selectively applied to one or more processes within application 112. For example, a new feature of application 112 may be released in a patch. An administrator of application 112 may choose to implement the new feature in only a subset of the processes in application 112. As a result, the patch may only be applied to the processes selected by the administrator rather than to the entirety of application 112. Consequently, patch-management framework 102 allows for efficient, dynamic, and customized installation and uninstallation of patches to and from application 112.

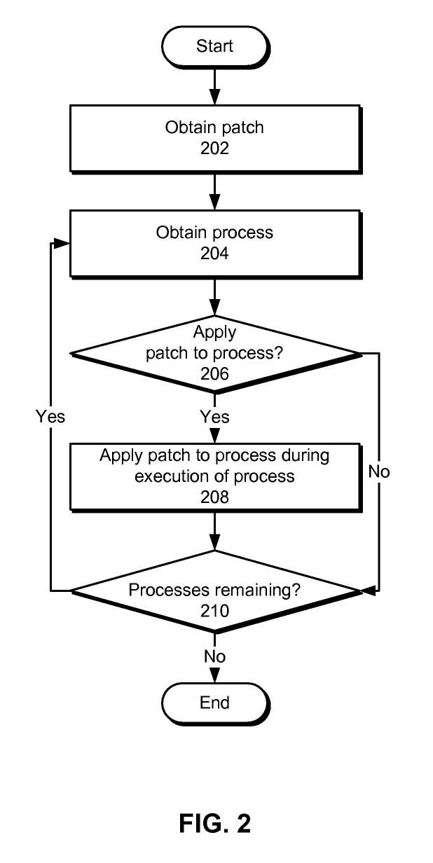

FIG. 2 shows a flowchart illustrating the process of patch installation on an application with multiple executing processes in accordance with an embodiment of the present invention. In one or more embodiments of the invention, one or more of the steps may be omitted, repeated, and/or performed in a different order. Accordingly, the specific arrangement of steps shown in FIG. 2 should not be construed as limiting the scope of the invention.

Initially, a patch for the application is obtained (operation 202). The patch may provide one or more changes to the application, such as a bug fix, a security fix, a compatibility fix, a diagnostic, an additional feature of the application, and/or an update to an existing feature of the application. Next, a process within the application is obtained (operation 204). The process may perform a specialized role within the application. For example, the process may implement a specific feature or provide error handling. Consequently, the patch may only be applied to the process if the patch is relevant to the process (operation 206).

If the patch is relevant to the process, the patch is applied to the process during the execution of the process (operation 208). To apply the patch during runtime, the patch may be loaded as a shared library and referenced from the application, as described above.

If processes remain in the application (operation 210), each process is obtained (operation 204) and examined for relevance to the patch. The patch is then applied to processes that require and/or implement the changes provided by the patch. For example, if the patch includes a new feature of the application, the patch may only be applied to processes that use or implement the new feature. The patch installation process is complete when the patch is applied to all relevant processes within the application.

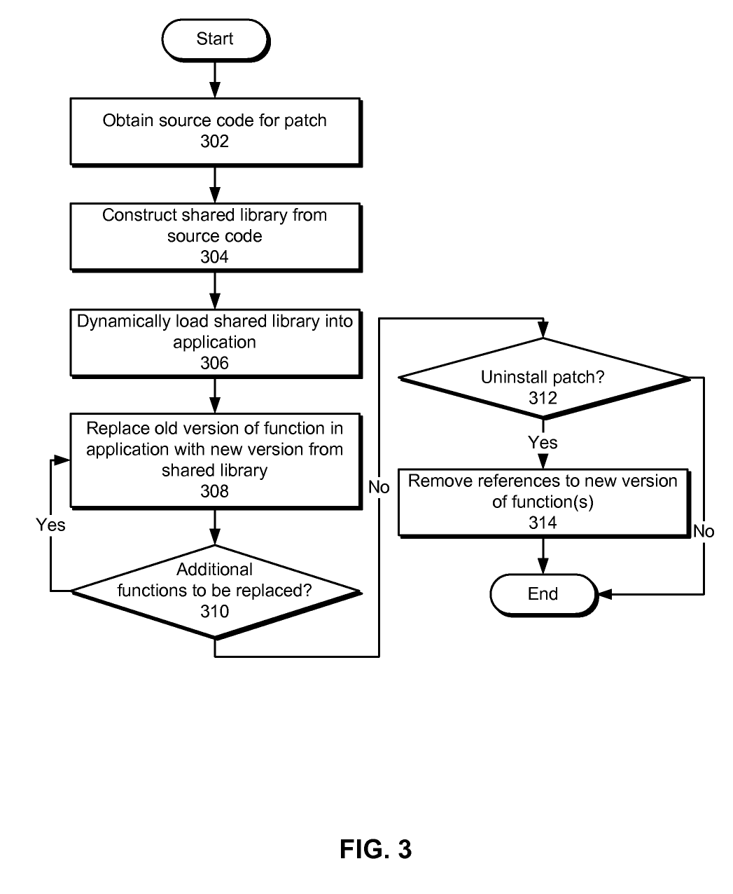

FIG. 3 shows a flowchart illustrating the process of applying a patch to an application during execution of the application in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

First, source code for the patch is obtained (operation 302). The source code may be obtained from a patch repository, such as patch repository 110 of FIG. 1. The source code may be written in a programming language, such as C++, Java, Assembly, and/or Fortran. In addition, the source code may be created by a developer of the application and/or generated automatically using a model of the application.

Next, a shared library corresponding to the patch is constructed from the source code (operation 304). To construct the shared library, the source code may be compiled into one or more object files, which may then be placed into the shared library. Once the shared library is created, the shared library is dynamically loaded into the application (operation 306). In other words, the patch may be loaded into the address space of the application without interrupting the execution of the application.

To enact changes provided by the patch, an old version of a function in the application is replaced with a new version of the function from the shared library (operation 308). As discussed above, the old version may be replaced by changing references to the old version to refer to the new version. Such reference changes may occur within the function bodies of the old version, or in a symbol table for the application. If additional functions require replacement (operation 310) with new versions from the patch, the functions are also replaced by substituting references to the functions with references to the new versions (operation 308).

The patch may also be uninstalled (operation 312). For example, the patch may be uninstalled if a newer version of the patch is released, if the patch is not needed by the application, and/or if the patch is otherwise unsuitable for use with the application. To uninstall the patch, the application is updated by removing references to the new versions of the functions from the shared library (operation 314), thus removing changes to the application associated with the patch.

The foregoing descriptions of embodiments have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for applying a patch to an application during execution of the application, comprising:
obtaining source code for the patch;
constructing a shared library from the source code;
dynamically loading the shared library into the application; and
replacing an old version of a function in the application with a new version of the function from the shared library, wherein the new version of the function changes the execution of the application in accordance with the patch.

2. The method of claim 1, wherein replacing the old version of the function involves changing a reference to the old version to refer to the new version.

3. The method of claim 2, wherein the old version of the function is included in an old version of the patch.

4. The method of claim 2, further comprising:
uninstalling the patch during application execution by removing the reference to the new version of the function.

5. The method of claim 1, wherein the application is implemented to be executed by multiple processes.

6. The method of claim 5, wherein the patch is applied to some of the processes.

7. The method of claim 1, wherein the application comprises a relational database management system (RDBMS).

8. The method of claim 1, wherein the patch provides at least one of a bug fix, a security fix, a compatibility fix, a diagnostic, an additional feature of the application, and an update to an existing feature of the application.

9. A system for applying a patch to an application during execution of the application, comprising:
a patch repository containing source code for to the patch; and
a patch-management framework, comprising:
a patch generator configured to construct a shared library from the source code;
a patch loader configured to dynamically load the shared library into the application; and
a patch installer configured to replace an old version of a function in the application with a new version of the function from the shared library.

10. The system of claim 9, wherein replacing the old version of the function involves updating a reference to the old version to refer to the new version.

11. The system of claim 10, wherein the old version of the function is included in an old version of the patch.

12. The system of claim 10, wherein the patch installer is further configured to uninstall the patch during application execution by removing the reference to the new version of the function.

13. The system of claim 9, wherein the application is implemented to be executed by multiple processes.

14. The system of claim 13, wherein the patch is applied to some of the processes.

15. The system of claim 9, wherein the application comprises a relational database management system (RDBMS).

16. The system of claim 9, wherein the patch provides at least one of a bug fix, a security fix, a compatibility fix, a diagnostic, an additional feature of the application, and an update to an existing feature of the application.

17. A computer-readable storage medium storing instructions that when executed by a computer cause the computer to perform a method for applying a patch to an application during execution of the application, the method comprising:
obtaining source code for the patch;
constructing a shared library from the source code;
dynamically loading the shared library into the application; and
replacing an old version of a function in the application with a new version of the function from the shared library, wherein the new version of the function changes the execution of the application in accordance with the patch.

18. The computer-readable storage medium of claim 17, wherein replacing the old version of the function involves updating a reference to the old version to refer to the new version.

19. The computer-readable storage medium of claim 18, wherein uninstalling the patch during application execution involves removing the reference to the new version of the function.

20. The computer-readable storage medium of claim 18, the method further comprising:
uninstalling the patch during application execution by removing the reference to the new version of the function.

21. The computer-readable storage medium of claim 17, wherein the application is implemented to be executed by multiple processes.

22. The computer-readable storage medium of claim 21, wherein the patch is applied to some of the processes.

23. The computer-readable storage medium of claim 17, wherein the application comprises a relational database management system (RDBMS).

24. The computer-readable storage medium of claim 17, wherein the patch provides at least one of a bug fix, a security fix, a compatibility fix, a diagnostic, an additional feature of the application, and an update to an existing feature of the application.
